(19) United States
(12) Patent Application Publication
(10) Pub. No.: US 2026/0309095 A1
(43) Pub. Date: Oct. 8, 2026

(54) METHOD FOR CONTROLLING A TURBINE ENGINE COMPRISING AN ELECTRIC MACHINE

(71) Applicant: SAFRAN AIRCRAFT ENGINES, PARIS (FR)

(72) Inventors: Seif Eddine BENATTIA, MOISSY-CRAMAYEL (FR); Rudy Charles André AULNETTE, MOISSY-CRAMAYEL (FR)

(21) Appl. No.: 19/483,751

(22) PCT Filed: May 24, 2024
(86) PCT No.: PCT/EP2024/064324

§ 371 Date: Nov. 12, 2025

(30) Foreign Application Priority Data
May 31, 2023 (FR) 2305462

(51) Int. Cl. F02C 9/26; F02C 6/00

(52) U.S. Cl. CPC F02C 9/26; F02C 6/00

(57) ABSTRACT

A method for controlling a turbine engine including an electric machine. The control method including a first fuel control loop determining a fuel flow rate setpoint and a second torque control loop determining an electrical torque setpoint. The torque control loop being configured to determine the electrical torque setpoint on the basis of a determined transient torque setpoint, an earlier electrical torque setpoint and a transient phase indicator. The control setpoint being determined on the basis of an earlier control setpoint, a time constant and the earlier electrical torque setpoint according to a decreasing mathematical law of the first order.

### TECHNICAL FIELD

The present invention relates to an aircraft turbine engine, in particular to the control of a turbine engine in order to provide the desired thrust as a function of the aircraft pilot's joystick position.

The climate change is a major concern for many legislative and regulatory members around the world. In fact, various restrictions on carbon emissions have been, are being or will be adopted by different countries. In particular, an ambitious standard applies both to new airplane types and to those already in circulation, requiring the implementation of technological solutions to bring them into line with current regulations. The civil aviation industry has been mobilizing for several years now to make a contribution to the fight against climate change.

The technological research efforts have already led to significant improvements in the environmental performance of airplanes. The Applicant takes into account the impacting factors in all phases of design and development to obtain aeronautical components and products that consume less energy, are more respectful of the environment and whose integration and use in civil aviation have moderate environmental consequences with the aim of improving the energy efficiency of airplanes.

Consequently, the Applicant is constantly working to reduce its negative impact on the climate through the use of virtuous development and the manufacturing methods and processes that minimize the greenhouse gas emissions to the minimum possible in order to reduce the environmental footprint of its activity.

This ongoing research and development work focuses on the new generations of aircraft engines, making the apparatus lighter, particularly through the use of lighter materials and onboard equipment, developing the use of electric technologies for propulsion, and, as an essential complement to technological progress, the aeronautical biofuels.

With reference to FIG. 1, a turbine engine 100 of the dual-flow turbojet engine and two-spool engine type for aircraft is shown schematically. In a known manner, the turbine engine 100 comprises, from upstream to downstream in the direction of gas flow, a fan 110, a low-pressure compressor 111, a high-pressure compressor 112, a combustion chamber 113 which receives a fuel flow rate setpoint WFcmd, a high-pressure turbine 114, a low-pressure turbine 115 and a primary exhaust nozzle 116. The low-pressure (or BP) compressor 111 and low-pressure turbine 115 are connected by a low-pressure shaft 121 and together form a low-pressure body. The high-pressure (or HP) compressor 112 and the high-pressure turbine 114 are connected by a high-pressure shaft 122 and together form a high-pressure body. The fan 110, driven by the low-pressure shaft 121, compresses the ingested air. This air is divided downstream of the fan 110 into a secondary air flow, which is directed directly to a secondary nozzle (not shown), through which it is ejected, and a so-called primary air flow, which enters the gas generator, consisting of the low-pressure body and the high-pressure body, and is then ejected into the primary nozzle 116. In a known way, to modify the speed of the turbine engine 100, the pilot of the aircraft modifies the position of a control lever which allows to modify the setpoint fuel flow rate WFcmd in the combustion chamber 113.

The design of a turbine engine 100 requires a sufficient margin against the phenomenon known as pumping. This phenomenon, which results from the air flow impinging excessively on the vanes of one of the compressors, leads to significant and rapid fluctuations in pressure downstream of the compressor in question, and may lead to the extinction of the combustion chamber 113. It also generates significant shocks on the vanes of the compressor, which may lead to mechanical damage. It is therefore particularly important to avoid its appearance. The operation of a compressor in use is generally represented by a diagram expressing the pressure ratio obtained between the outlet and the inlet, as a function of the air flow rate through it; this diagram is also parameterized as a function of the rotation speed of the compressor. This diagram shows a pumping line, which represents the maximum compression ratio limit that must not be exceeded to avoid the risk of pumping. In a known way, an operating line is defined, associating the compression ratios obtained as a function of the flow rate, when the turbine engine 100 is in stabilized operation. The positioning of this operating line is left to the discretion of the designer of the turbine engine 100, and the distance from this operating line to the pumping line represents the pumping margin. It's worth noting that the compressor's efficiency (compression work supplied to the air, in relation to the work supplied to drive it in rotation) is, to a first approximation, better the closer you get to the pumping line. On the other hand, the accelerations requested by the pilot from stabilized operation (transient phase) to obtain an increase in thrust, translate at the compressor level into an excursion of the operating point in the direction of the pumping line.

Indeed, additional fuel injection into the combustion chamber 113 causes an almost instantaneous rise in the compression ratio, even though the rotational speed has no time to increase due to inertia. The change in enthalpy brought to the fluid by the combustion of the added fuel then generates an increase in the work supplied by each turbine and, consequently, an increase in the speed of rotation of the corresponding body. This is reflected in the compressor diagram by a return of the operating point on the operating line when the speed stabilizes again, at an operating point corresponding to a higher flow rate than at the previous operating point.

The designer of a turbine engine 100 must therefore try to optimize the positioning of the operating line by placing it as high as possible, so as to benefit from better compressor efficiencies, while maintaining sufficient distance from the pumping line to enable safe acceleration.

In order to avoid any pumping phenomenon, a turbine engine 100 comprises a control system implemented by an electronic unit. With reference to FIG. 2, the control system comprises a stabilized management module 31, a transient intention detection module 32, a speed trajectory generation module 33, a transient management module 33′, a selection module 34, an integration module 35 and a stop management module 36.

The transient management module 33′ supplies a correction variable to the selection module 34 as a function of the difference between the speed NL of the turbine engine 100 and the trajectory output by the generation module of a speed trajectory 33. The stabilized management module 31 supplies a correction variable to the selection module 34 as a function of the difference between the speed NL of the turbine engine 100 and the setpoint speed NL_{CONS}. The speed NL may correspond to different types of speed, such as a fan speed, a pressure setpoint known by its acronym EPR (Engine Pressure Ratio), a high-pressure setpoint or other.

The setpoint speed NL_{CONS} is proportional to the position of the control lever manipulated by the pilot of the aircraft. Such a stabilized management module 31 is known to the person skilled in the art and will not be presented in greater detail.

The purpose of the transient intention detection module 32 is to detect a transient intention desired by the pilot. The transient intention detection module 32 determines a difference between the speed NL of the turbine engine 100 and the setpoint speed NL_{CONS}. When the joystick remains in a constant position and the stabilized management module 31 is activated, the actual speed NL of the turbine engine 100 is stationary and equal to the setpoint speed NL_{CONS}. If the pilot moves the joystick, the setpoint speed NL_{CONS} varies instantaneously. On the contrary, the speed NL does not vary instantaneously due to the inertia of the turbine engine 100 and the stabilized management module 31. Thus, the transient intention detection module 32 detects a transient intention when the difference between the setpoint speed NL_{CONS} and the actual speed NL is greater than a predetermined threshold S2.

In the case of an acceleration request, if the speed deviation is greater than the predetermined threshold S2 (NL_{CONS}-NL>S2), an acceleration request is detected. Similarly, in the case of deceleration, if the speed deviation is greater than the predetermined threshold S2 (NL-NL_{CONS}>S2), a deceleration request is detected. When a transient phase is detected, the transient intention detection module 32 generates an activation signal, which is transmitted to the speed trajectory generation module 33 and the selection module 34 as shown in FIG. 2.

In the case of an acceleration request, the speed trajectory generation module 33 determines a speed setpoint for the acceleration (acceleration trajectory). Similarly, in the case of deceleration, the engine speed trajectory generation module 33 determines an engine speed setpoint for deceleration (deceleration trajectory). Depending on the trajectory generated, the speed trajectory generation module 33 supplies a correction variable to the selection module 34.

Such a module for generating a speed trajectory 33 is known to the person skilled in the art, in particular from the patent application US2013/0008171 and the patent application FR2977638A1, and will not be presented in greater detail.

In this example, the selection module 34 is configured to receive an activation signal from the transient intention detection module 32. The selection module 34 selects the correction variable from the stabilized management module 31 if no activation signal is received, and selects the correction variable from the transient management module 33′ if an activation signal is received. Such a selection module 34 is known to the skilled person and will not be presented in further detail. The selected correction variable is supplied to the integration module 35. The integration module 35 determines the fuel flow rate setpoint WFcmd by integrating the selected correction variable.

The stop management module 36 limits the value of the fuel flow rate setpoint WFcmd determined by the integration module 35. In a known way, the stop management module 36 implements a stop, known as a stop C/P, to protect the turbine engine against pumping. In this example, the stop management module 36 allows to define acceleration and deceleration stop setpoints. Such stops are known to the skilled person and will not be discussed further.

The speed trajectory generation module 33 and the stop management module 36 allow to define an acceleration trajectory that limits the fuel flow rate setpoint WFcmd to avoid pumping. Such a control system is known from the patent application FR2977638A1 and will not be presented in further detail. Incidentally, it is known to protect a motor against the phenomenon of pumping during transients by taking into account an acceleration setpoint during regulation (see for example U.S. Pat. No. 4,543,782 and US 2003/0094000).

In order to improve the response time of a turbine engine during a transient phase (acceleration, deceleration, etc.), it has been proposed to equip the turbine engine with an electric machine to provide additional electrical torque to increase the speed of the turbine engine without leading to a pumping phenomenon. For this purpose, the patent application WO2016/020618 describes an aircraft turbine engine comprising an electric machine for drawing power from the low-pressure shaft and injecting power into the high-pressure shaft. Incidentally, the patent applications FR3116865A1 and FR3087491A1 describe methods for controlling a turbine engine comprising an electric motor.

To reduce the energy consumption of the electric machine, it is known to use the electric machine only during a transient phase. In practice, the electric machine is stopped at the end of the transient phase, resulting in a sudden loss of torque (step change) which is automatically compensated for by a change in the fuel flow rate setpoint WFcmd.

This may cause significant variations in speed and repeated activation/deactivation of the electric motor, which may adversely affect the thrust and service life of the electric motor.

The aim of the invention is to eliminate at least some of these disadvantages by proposing a method for controlling a turbine engine allowing the management of the electric machine after a transient phase.

### PRESENTATION OF THE INVENTION

To this end, the invention is the result of technological research aimed at significantly improving the performance of the aircrafts and, in this sense, contributes to reducing the environmental impact of the aircrafts. To this end, the invention relates to a method for controlling a turbine engine comprising a fan positioned upstream of a gas generator and delimiting a primary flow and a secondary flow, said gas generator being traversed by the primary flow and comprising a low-pressure compressor, a high-pressure compressor, a combustion chamber, a high-pressure turbine and a low-pressure turbine, said low-pressure turbine being connected to said low-pressure compressor by a low-pressure rotation shaft and said high-pressure turbine being connected to said high-pressure compressor by a high-pressure rotation shaft, the turbine engine being configured to be in a transient phase or in a stabilized phase, the turbine engine comprising an electric machine configured to apply a torque to the low-pressure rotation shaft or to the high-pressure rotation shaft during the transient phase, a method wherein a fuel flow rate setpoint in the combustion chamber and an electrical torque setpoint supplied to the electric machine are determined, the control method comprising a first fuel control loop determining the fuel flow rate setpoint and a second torque control loop determining the electrical torque setpoint.

The invention is remarkable in that:
The second torque control loop is configured to determine the electrical torque setpoint from a determined transient torque setpoint, a previous electrical torque setpoint and a transient phase indicator,
The second torque control loop is configured, when the transient phase indicator is inactive, to determine that the electrical torque setpoint is equal to a control setpoint, the control setpoint being determined from a previous control setpoint, a time constant and the previous electrical torque setpoint according to a decreasing mathematical law of the first order.

Thanks to the invention, the electrical torque setpoint is reduced quickly and in a controlled manner, while limiting static error. This allows to reduce the power consumption after a transient phase, while avoiding an abrupt reset which could lead to compensation by the first fuel control loop. This ensures optimum resetting of the electrical torque setpoint.

Preferably, the mathematical law is equal to

$$TRQcont = {TRQcmd}_{- 1} - ( {TRQcont}_{- 1} ) * {e}^{- t * tau}$$

In which
TRQcont is the control setpoint
TRQcont−1 is the previous control setpoint
tau is the time constant
TRQcmd−1 is the previous electrical torque setpoint
t represents time.

Advantageously, the time constant tau is an image of the cancellation speed of the electrical torque and may advantageously be parameterized.

Preferably, the torque control loop is configured to reset the control setpoint to zero when the absolute value of the previous control torque setpoint is less than a predetermined extinction constant. Thus, this prevents a very slow shutdown of the electrical supply when the electrical supply is low. This avoids any inappropriate use of the electrical machine.

In one aspect, the time constant governing the resetting of the control setpoint is parameterizable. This allows the torque reset dynamics to be conveniently set to match the dynamics of the first fuel control loop.

According to one aspect, the torque control loop is configured to receive transient indicators from the fuel control loop and to determine the transient phase indicator from the transient indicators.

According to one aspect, the torque control loop is configured to add an aircraft power bleed setpoint to the electrical torque setpoint. Thus, the electrical torque setpoint may take into account both transient conditions and the aircraft's electrical power requirements.

The invention also relates to a computer program comprising instructions for executing the steps of a control method as hereinbefore presented when said program is executed by a computer.

The invention also relates to an electronic control unit for a turbine engine comprising a memory including instructions of a computer program as previously presented.

The invention also relates to a turbine engine comprising an electronic unit as described above.

### PRESENTATION OF FIGURES

The invention will be better understood on reading the following description, which is given by way of example, with reference to the following figures, given as non-limiting examples, in which identical references are given to similar objects.

FIG. 1 is a schematic representation of a turbine engine according to the prior art.

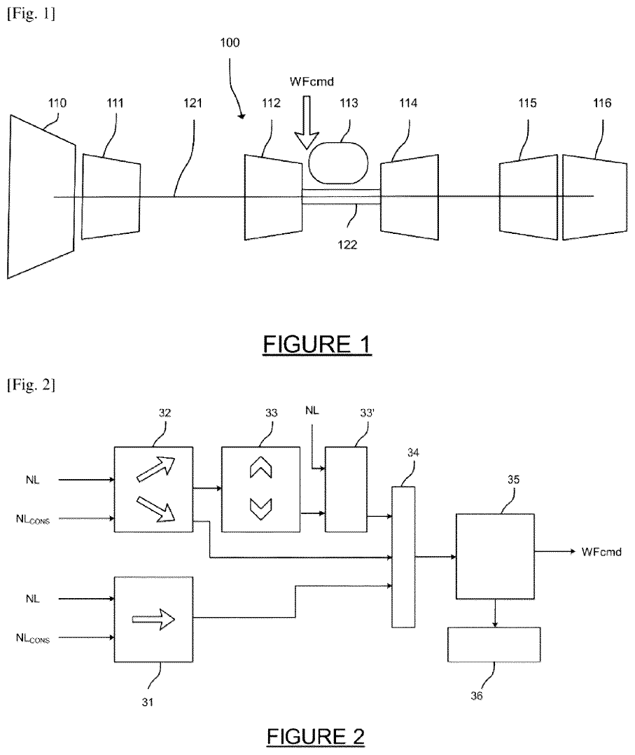

FIG. 2 is a schematic representation of a control system of a fuel flow rate setpoint according to the prior art.

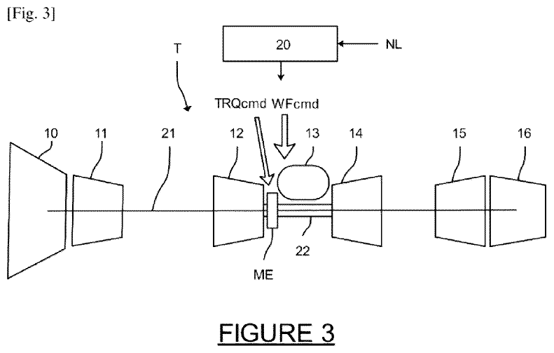

FIG. 3 is a schematic representation of a turbine engine according to one embodiment of the invention.

FIG. 4 is a schematic representation of a control system of a fuel flow rate setpoint and an electrical torque setpoint.

FIG. 5 is a schematic representation of a control loop of the electrical torque setpoint.

FIG. 6 is a schematic representation of a transient determination block.

FIG. 7 is a schematic representation of a control module.

FIG. 8 is a schematic representation of several mathematical laws of torque reduction to zero.

FIG. 9 is a schematic representation of torque reductions to zero according to a first decreasing order for different time constants.

The FIG. 10 is a schematic representation of the evolution of several physical quantities over time during changes in the operating conditions of the turbine engine.

The FIG. 11 is a schematic representation of a system for controlling a fuel flow rate setpoint and a torque setpoint, taking into account an electrical bleed from the aircraft in the control of the electrical torque setpoint.

The FIG. 12 is a schematic representation of a control loop of the electrical torque setpoint that takes into account the electrical bleed from the aircraft.

It should be noted that the figures set out the invention in detail in order to implement the invention, said figures of course being able to be used to better define the invention where appropriate.

### DETAILED DESCRIPTION OF THE INVENTION

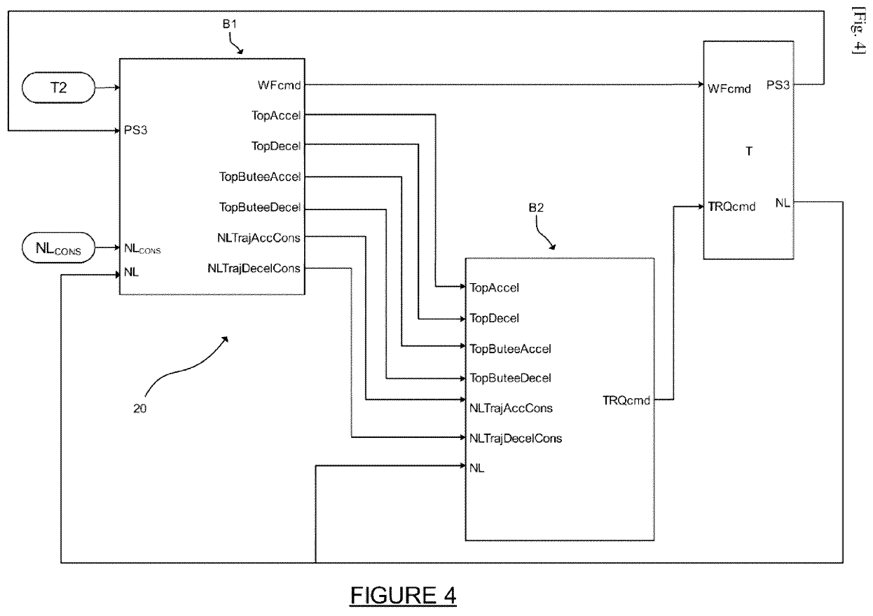

With reference to FIG. 3, a turbine engine T of the dual-flow turbojet engine and two-spool engine type for aircraft is shown schematically. In a known way, the turbine engine T comprises, from upstream to downstream in the direction of gas flow, a fan 10, a low-pressure compressor 11, a high-pressure compressor 12, a combustion chamber 13 which receives a fuel flow rate setpoint WFcmd, a high-pressure turbine 14, a low-pressure turbine 15 and a primary exhaust nozzle 16. The low-pressure (or BP) compressor 11 and the low-pressure turbine 15 are connected by a low-pressure shaft 21 and together form a low-pressure body. The high-pressure (or HP) compressor 12 and high-pressure turbine 14 are connected by a high-pressure shaft 22 and together with the combustion chamber 13 form a high-pressure body. The fan 10, which is driven by the low-pressure shaft 21, compresses the ingested air. This air is divided downstream of the fan 10 between a secondary air flow that is directed directly to a secondary nozzle (not shown) through which it is ejected to contribute to the thrust provided by the turbine engine T, and a so-called primary flow that enters the gas generator, consisting of the low-pressure body and the high-pressure body, and is then ejected into the primary nozzle 16. In a known way, to modify the speed of a turbine engine T, the pilot of the aircraft modifies the position of a control lever which allows the fuel flow rate setpoint WFcmd in the combustion chamber 13 to be modified.

With reference to FIG. 3, the turbine engine T also comprises an electric motor ME configured to supply additional torque to the low-pressure shaft 21 or the high-pressure shaft 22. The operation of the turbine engine T is controlled by an electronic unit 20, which obtains signals representing operating parameters of the turbine engine T, in particular a speed NL of the turbine engine T, to supply the fuel flow rate setpoint WFcmd and a torque setpoint TRQcmd to the electric motor ME. The speed NL may correspond to different types of speed, such as a fan speed, a pressure setpoint known by its English acronym EPR (Engine Pressure Ratio), a high-pressure speed setpoint or other.

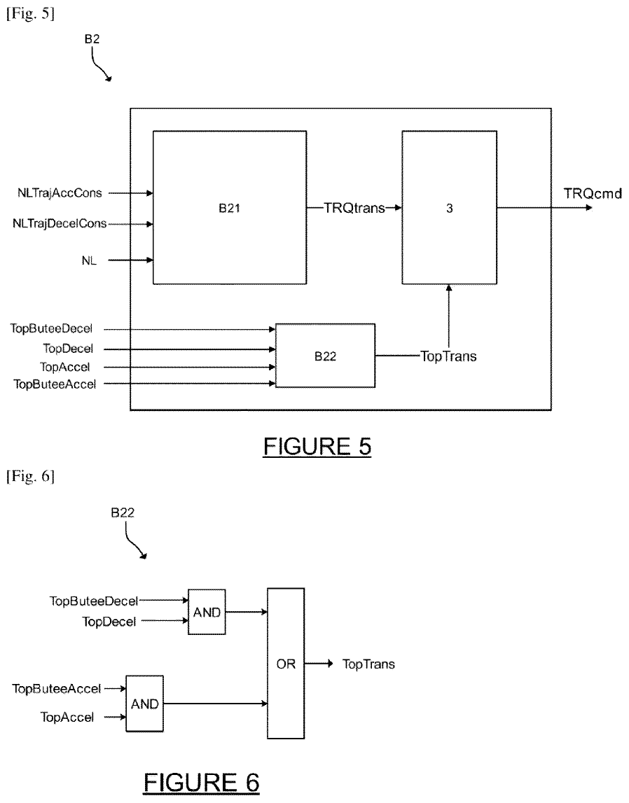

As illustrated in FIG. 4, the electronic unit 20 comprises a control system comprising a first loop B1 for controlling the fuel flow rate setpoint WFcmd, hereinafter referred to as “first fuel loop B1”, and a second loop B2 for controlling the electrical torque setpoint TRQcmd, hereinafter referred to as “second torque loop B2”.

As shown in FIG. 4, the first fuel loop B1 comprises:
A temperature input T2
a speed input NL from the turbine engine T
a setpoint speed input NL_{CONS} defined by the position of the joystick manipulated by the pilot of the aircraft,
a fuel flow rate setpoint output WFcmdtransmitted to the turbine engine T and
a plurality of output indicators:
   an indicator of an acceleration transient request TopAccel
   a deceleration transient request indicator TopDecel
   an acceleration stop indicator TopButeeAccel defined by the saturation of the corrector control by the acceleration C/P stop
   a deceleration stop indicator TopButeeDecel defined by the saturation of the corrector control by the extinction stop C/P
   a speed trajectory setpoint for the acceleration NLTrajAccCons
   a speed trajectory setpoint for the deceleration NLTrajDecelCons

Still referring to FIG. 4, the second torque loop B2 receives as input all the output indicators generated by the first fuel loop B1, i.e. TopAccel, TopDecel, TopButeeAccel, TopButeeDecel, NLTrajAccCons, NLTrajDecelCons, and the speed input NL of the turbine engine T.

Thanks to this control system, the second torque loop B2 is able to provide an adaptive torque setpoint TRQcmd as a function of the behavior of the first fuel loop B1, which retains priority. In this example, the first fuel loop B1 also comprises a static pressure inlet to the combustion chamber PS3.

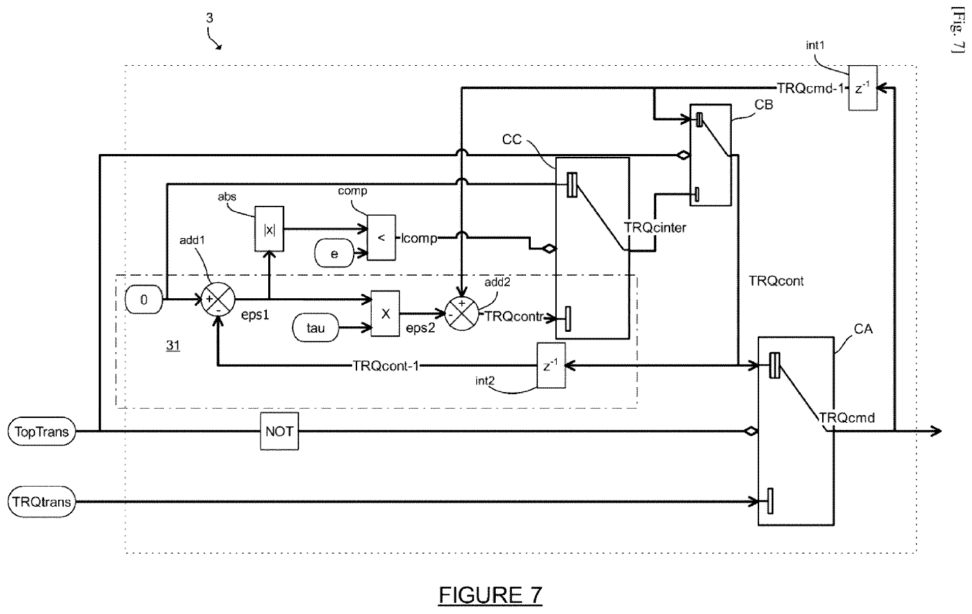

In detail, with reference to FIG. 5, the second torque loop B2 comprises a processing block B21 configured to determine a transient torque setpoint TRQtrans from the inputs NLTrajAccCons, NLTrajDecelCons, as well as the speed input NL of the turbine engine T. Such a processing block B21 is known from the prior art, in particular from the patent application WO2016/020618. The transient torque setpoint TRQtrans provides an electrical response to the needs of the turbine engine T during a transient regime.

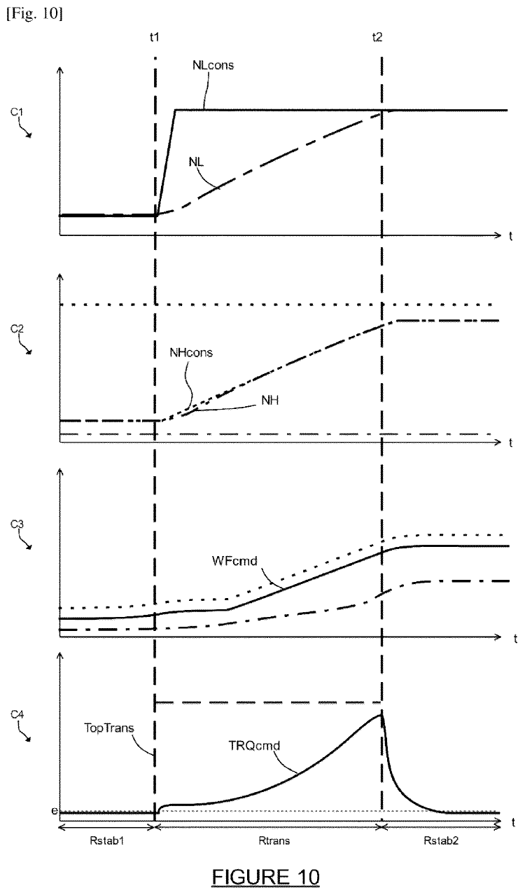

The second torque loop B2 further comprises a control module 3, shown schematically in FIG. 7, configured to determine the electrical torque setpoint TRQcmd from the transient torque setpoint TRQtrans, a previous electrical torque setpoint TRQcmd−1 and a transient phase indicator TopTrans.

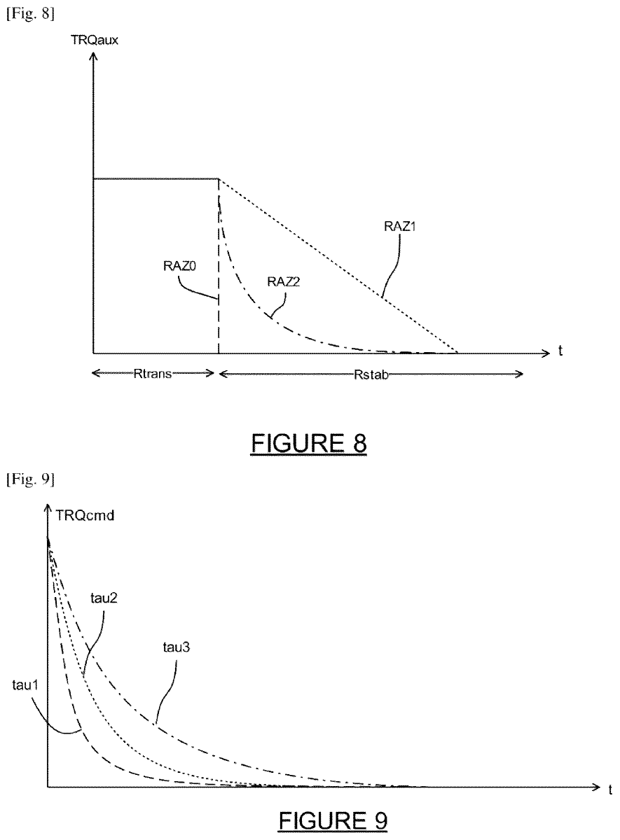

In this example, the transient phase indicator TopTrans is active when the turbine engine T is in transient state. To this end, as illustrated in FIG. 5, the second torque loop B2 comprises a transient determination block B22 for determining the transient phase indicator TopTrans. With reference to FIG. 6, the transient phase indicator TopTrans is determined from the inputs TopAccel, TopDecel, TopButeeAccel, TopButeeDecel. In particular, the transient phase indicator TopTrans is active:
when an acceleration is requested and the acceleration stop has already been reached (TopAccel and TopButeeAccel enabled)
when a deceleration is requested and the deceleration stop has already been reached (TopDecel and TopButeeDecel enabled).

Referring to FIG. 7, the control module 3 comprises a first switch CA configured to determine the electrical torque setpoint TRQcmd from the transient torque setpoint TRQtrans and a control setpoint TRQcont as a function of the transient phase indicator TopTrans.

Still referring to FIG. 7, as long as the TopTrans transient indicator is active, the first CA switch determines that the electrical torque setpoint TRQcmd is equal to the transient torque setpoint TRQtrans. In fact, when the turbine engine T is in transient state, the electric motor ME supplies a torque to meet the transient requirements of the turbine engine T.

When the TopTrans transient indicator is inactive, the first CA switch determines that the TRQcmd electrical torque setpoint is equal to the TRQcont control setpoint, which is designed to reduce electrical torque. The TRQcont control setpoint will now be introduced.

The control module 3 further comprises a second switch CB configured to determine the control setpoint TRQcont from a previous electrical torque setpoint TRQcmd−1 and an intermediate control setpoint TRQcinter as a function of the transient phase indicator TopTrans.

The control module 3 further comprises a third switch CC configured to determine the intermediate control setpoint TRQcinter from a reset setpoint and a reduced control setpoint TRQcontr as a function of a comparison indicator Icomp. The reduced control setpoint TRQcontr is determined from a previous electrical torque setpoint TRQcmd−1 and a previous control setpoint TRQcont−1.

In this example, the previous electrical torque setpoint TRQcmd−1 and the previous control setpoint TRQcont−1 are respectively determined by integrators int1, int2.

The various parameters will now be presented.

In this example, the reduced control setpoint TRQcontr is determined in a reduction loop 31 from the previous control setpoint TRQcont−1, a time constant tau and the previous electrical torque setpoint TRQcmd−1.

As long as the turbine engine T is in transient state, the second switch CB determines that the control setpoint TRQcont is equal to the previous electrical torque setpoint TRQcmd−1. This control setpoint TRQcont is used by the reduction loop 31 to determine the reduced control setpoint TRQcontr. This advantageously synchronizes the reduction loop 31 with the electrical torque setpoint TRQcmd, so that the value of the previous control setpoint TRQcont−1 is in continuity with the values of the electrical torque setpoint TRQcmd. When the turbine engine T returns to steady state, the second switch CB sets the control setpoint TRQcont as the intermediate torque setpoint, the electrical torque at the starting point of the reset is thus the electrical torque at the end point of the transient state. The transition is advantageously smooth.

As shown in FIG. 7, the previous control setpoint TRQcont−1 and a target value 0 (reset setpoint) are compared by an adder add1 to determine a primary deviation eps1. The primary deviation eps1 is then multiplied by the time constant tau in a multiplier block to obtain a secondary deviation eps2. The secondary deviation eps2 is then added to the previous electrical torque setpoint TRQcmd−1 via an adder add2 to determine the reduced control setpoint TRQcontr.

In other words, the reduction loop 31 allows to determine the TRQcont control setpoint according to the following decreasing mathematical law of the first order.

$$TRQcont = {TRQcmd}_{- 1} - ( {TRQcont}_{- 1} ) * {e}^{- t * tau} \qquad [ Math . 1 ]$$

The absolute value of the primary deviation eps 1 is determined by an absolute value block abs, and is compared with a predetermined extinction constant e by a comparison block comp to determine a comparison indicator Icomp. In practice, the comparison indicator Icomp is active if the absolute value of the primary deviation eps 1 is less than the predetermined extinction constant e. The predetermined extinction constant e is configured to be close to 0 (reset setpoint) in order to force a reset of the electrical torque when electrical requirements are low. This allows you to prevent unintended use of the electric machine ME. This also allows us to avoid a slow convergence to zero with a first-order mathematical law.

In this example, still referring to FIG. 7, when the Icomp control indicator is inactive, the third switch CC determines that the TRQcinter intermediate control setpoint is equal to the reduced control setpoint TRQcontr. This implementation enables the output value of the switch CB to be reduced in a beneficial manner according to the mathematical law of the first decreasing order as long as the Icomp control indicator is inactive. This allows the turbine engine T to switch from one stabilized speed to another, while conserving the electrical resources.

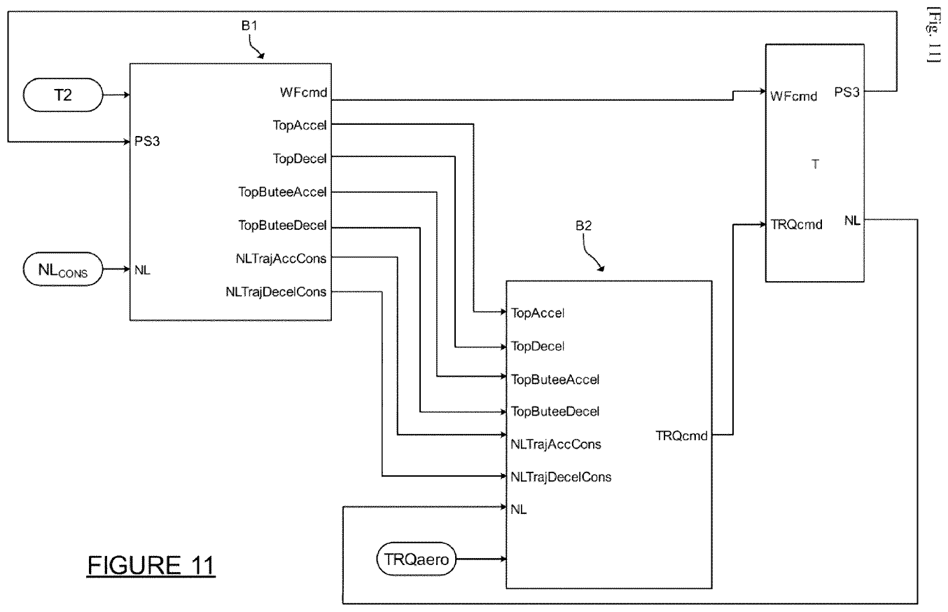

Thanks to the invention, with reference to FIG. 8, during a transition from a transient state Rtrans to a steady-state phase Rstab, the control setpoint TRQcont is gradually reset to zero according to a first-order mathematical law RAZ2, which enables:
Limiting jolts on the electric machine ME by comparison with a sudden reset according to a mathematical law defining a step RAZ0 and
Conserving the electrical resources by comparison with a very gradual reset according to a mathematical law defining a decreasing ramp RAZ1.

A sudden reset by a step RAZ0 also has the disadvantage of causing transition problems between the transient state phase Rtrans and the steady-state phase Rstab, and untimely switching between these two phases. A very gradual reset with a decreasing ramp RAZ1 also has the disadvantage of causing a continuous error in the electrical torque.

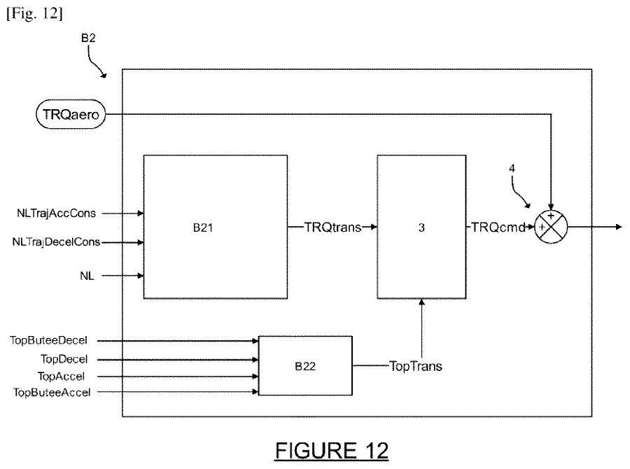

Preferably, the time constant tau of the first-order mathematical law of the reduction loop 31 is parameterized. With reference to FIG. 9 showing several values of time constant tau1, tau2, tau3, the speed of the response may be set.

An example of implementation will be presented with reference to FIG. 10 during an increase in speed decided by the pilot of the aircraft.

As shown on the curve C1, when a request is made for an increase in speed, the low-pressure setpoint NLcons increases sharply at a first instant t1, starting a transient state phase Rtrans. The low-pressure speed NE progressively follows the low-pressure speed setpoint NLcons, in order to avoid any pumping of the turbine engine T. At a second instant t2, the low-pressure speed NL is close to the low-pressure speed setpoint NLcons, thus ending the transient state phase Rtrans. The transient state Rtrans is preceded by a first steady-state phase Rstab1 and followed by a second steady-state phase Rstab2.

As shown in the curve C2, the high-pressure torque setpoint NHcons is followed reactively by synergistic cooperation between the fuel setpoint WFcmd (Curve C3) and the electrical torque setpoint TRQcmd (Curve C4).

As shown on the curve C3, the fuel setpoint WFcmd increases gradually during a transient state phase Rtrans.

During the transient state phase Rtrans, as shown on the curve C4, the transient indicator TopTrans is active and the electrical torque setpoint TRQcmd corresponds to the transient torque setpoint TRQtrans. The reduction loop 31 is disconnected from the output of the second torque loop B2. In this example, the second control loop B2 gradually increases the torque of the electric machine on the high-pressure shaft 22. The result is a gradual increase in the speed of rotation of the high-pressure shaft 22.

After the end of the transient state phase Rtrans, the transient indicator TopTrans is inactive (the TopAccel acceleration transient indicator is lowered) and the torque setpoint TRQcmd is progressively reset to zero according to the mathematical law of the first order. This enables the first fuel loop B1, which has regained control of the fuel setpoint WFcmd, to regulate the speed of the low-pressure shaft 21 without disturbance. When the primary deviation eps1 is small compared with the predetermined extinction constant e, the electrical torque setpoint TRQcmd is reset directly to zero to conserve the electrical resources.

According to one aspect of the invention, with reference to FIG. 11, the second torque loop B2 also receives as input an aircraft bleed setpoint TRQaero to meet the aircraft's electrical requirements, in particular, to enable electrical generation.

To this end, as illustrated in FIG. 12, the second torque loop B2 also comprises an adder 4, which adds an aircraft bleed setpoint TRQaero to the electrical torque setpoint TRQcmd determined by the control module 3. Thus, advantageously, only the part of the electrical torque setpoint TRQcmd linked to the transient state is reset to zero. The electrical machine ME may continue to supply electrical power to the aircraft.

1. A method for controlling a turbine engine comprising a fan positioned upstream of a gas generator and delimiting a primary flow and a secondary flow, said gas generator being traversed by the primary flow and comprising a low-pressure compressor, a high-pressure compressor, a combustion chamber, a high-pressure turbine and a low-pressure turbine, said low-pressure turbine being connected to said low-pressure compressor by a low-pressure rotation shaft and said high-pressure turbine being connected to said high-pressure compressor by a high-pressure rotation shaft, the turbine engine being configured to be in a transient phase or in a stabilized phase, the turbine engine comprising an electric machine configured to apply a torque to the low-pressure rotation shaft or to the high-pressure rotation shaft during the transient phase, wherein a fuel flow rate setpoint in the combustion chamber and an electrical torque setpoint supplied to the electric machine are determined, the method comprising:
determining the fuel flow rate setpoint with a first fuel control loop,
determining the electrical torque setpoint with a second torque control loop, and
determining the electrical torque setpoint from a determined transient torque setpoint, a previous electrical torque setpoint, and a transient phase indicator with the second torque control loop, wherein
the second torque control loop is configured when the transient phase indicator is inactive, to determine that the electrical torque setpoint is equal to a control setpoint, and wherein the control setpoint is determined from a previous control setpoint, a time constant, and the previous electrical torque setpoint according to a decreasing mathematical model of the first order.

2. The method for controlling a turbine engine according to claim 1, wherein the decreasing mathematical model is
$$TRQcont = {TRQcmd}_{- 1} - ( {TRQcont}_{- 1} ) * {e}^{- t * tau}$$
wherein TRQcont is the control setpoint,
TRQcont−1 is the previous control setpoint, tau is the time constant,
TRQcmd−1 is the previous electrical torque setpoint, and t represents time.

3. The method for controlling a turbine engine according to claim 1, wherein the torque control loop is configured to reset the control setpoint to zero when the absolute value of the previous control torque setpoint is less than a predetermined extinction constant.

4. The method for controlling a turbine engine according to claim 1, wherein the time constant governing the resetting of the control setpoint is parameterizable.

5. The method for controlling a turbine engine according to claim 1, wherein the torque control loop is configured to receive transient indicators emitted by the fuel control loop and to determine the transient phase indicator from the transient indicators.

6. The method for controlling a turbine engine according to claim 1, wherein the torque control loop is configured to add an aircraft power bleed setpoint to the electrical torque setpoint.

7. A computer program comprising instructions for executing the steps of the method according to claim 1 when said program is executed by a computer.

8. An electronic control unit for the turbine engine comprising a memory including instructions of the computer program according to claim 7.

9. The turbine engine comprising the electronic unit according to claim 8.
